(19) United States
(12) Patent Application Publication
(10) Pub. No.: US 2009/0167057 A1
(43) Pub. Date: Jul. 2, 2009

(54) Tractor Cab Suspension System

(76) Inventors: Benjamin G. Walter, Lethbridge (CA); Dean Antal, Lethbridge (CA)

Correspondence Address: ADE & COMPANY INC., 2157 Henderson Highway, WINNIPEG, MB, R2G1P9, CA

(21) Appl. No.: 11/968,529

(22) Filed: Jan. 2, 2008

(51) Int. Cl. B60R 21/13; B62D 33/06

(52) U.S. Cl. 296/190.03

(57) ABSTRACT

A tractor cab suspension system includes a plurality of suspension members arranged for supporting the cab on the frame in which some of the suspension members at one end of the cab comprise resilient members compressed between the cab and the frame of the tractor and other ones of the suspension members at the other end of the cab comprise air cushion members. A rollover protection member is associated with each air cushion member to resist separation of the cab from the frame at the cushion member during a rollover of the tractor. The rollover protection members are arranged to couple the cab and the frame for linear sliding movement relative to one another.

### FIELD OF THE INVENTION

The present invention relates to an operator cab air suspension system using a rollover protection member to resist separation of the cab from the frame during a rollover for use in tractors and the like.

### BACKGROUND

A known type of tractor design involves supporting the tractor frame on forward and rearward pairs of tracks in which the frame is articulated for steering between the forward and rearward tracks. An operator cab is typically supported on the frame for housing an operator of the tractor. The cab is typically supported directly on the frame by resilient mounts compressed between the cab and the frame by threaded fasteners mounted directly between the cab and the frame. When the frame is supported for rolling movement on the ground on tracks instead of pneumatic tires, vibrations from the rolling movement across the ground are readily transmitted through the frame to the operator cab resulting in extreme amounts of vibration transmitted to the cab. The operator thus experiences considerable discomfort from noise, excessive cab vibrations and related rattles while the vibrations can cause failures of some of the operator equipment in the cab.

The use of various cab suspension systems are known in highway tractor trucks, however such suspension systems are generally not suitable for use in an agricultural tractor and the like where additional protection is required to prevent the cab being separated from the frame in the event of a rollover of the vehicle. Accordingly, while there exists suitable air cushion type suspensions for highway truck tractors to reduce vibrations transmitted from the frame to the cab, such systems do not meet the rollover protection requirements of work vehicles and agricultural tractors and the like, accordingly there is no readily available solution to improving the ride comfort of a cab in an agricultural tractor and the like.

### SUMMARY OF THE INVENTION

According to one aspect of the invention there is provided a cab suspension system for a work vehicle comprising a frame supported for rolling movement along the ground and an operator cab arranged to be supported on the frame and for supporting an operator of the work vehicle therein, the system comprising:

a plurality of suspension members arranged for supporting the cab on the frame;

at least one of the suspension members comprising an air cushion member arranged to be supported between the cab and the frame of the work vehicle; and

at least one rollover protection member arranged to resist separation of the cab from the frame during a rollover of the work vehicle;

said at least one rollover protection member being arranged to couple the cab and the frame for sliding movement relative to one another.

According to a second aspect of the present invention there is provided a tractor comprising:

a frame supported for rolling movement along the ground;

an operator cab arranged to be supported on the frame and arranged for supporting an operator of the work vehicle therein;

a plurality of suspension members arranged for supporting the cab on the frame;

at least one of the suspension members comprising an air cushion member arranged to be supported between the cab and the frame of the tractor; and

at least one rollover protection member arranged to resist separation of the cab from the frame at said at least one air cushion member during a rollover of the tractor;

said at least one rollover protection member being arranged to couple the cab and the frame for sliding movement relative to one another.

Use of a rollover protection member which both resists separation of the cab from the frame during a rollover of the vehicle while also permitting a relative linear sliding movement between the cab and the frame allows an air cushion suspension to be used for isolating vibrations from the cab while maintaining the required degree of protection against cab separation from the frame in a rollover of an agricultural tractor.

The rollover protection member preferably supports the cab for sliding movement relative to the frame in a substantially vertical direction between an upper limit and a lower limit, wherein said air cushion member supports the cab on the frame spaced between the upper limit and the lower limit of said at least one rollover protection member.

The air cushion members and the rollover protection members are preferably supported together at a rear end of the cab opposite other ones of the suspension members which are supported at the front end of the cab.

Two rollover protection members may be laterally spaced apart from one another with the air cushions being located between the two rollover protection members.

The rollover protection member may comprise a rigid rod member, a first mount fixing the rigid rod member to one of the cab and the frame and a second mount fixed to the other one of the cab and the frame, the second mount being supported for sliding movement along the rigid rod member.

The first mount preferably comprises an upper mount supported on the cab and the second mount preferably comprises a lower mount supported on the frame.

When an annular housing is supported on the second mount which receives the rod member therethrough such that an annular gap is defined between the annular housing and the rod member, preferably there is provided an annular cushion member of resilient material spanning the annular gap.

There may be provided a retainer member fixed adjacent one end of the annular housing opposite the first mount in which the annular cushion member is compressible between the retainer member and the first mount.

There may be provided an end plate fixed to one end of the rod member opposite the first mount in which the second mount is slidable along the rod member between the first mount and the end plate.

Preferably the rod member is generally tubular and there is provided a fastener extending through the rod member and through co-operating apertures in the first mount and in the end plate respectively such that the tubular rod member is clamped between the end plate and the first mount by the fastener extending therethrough.

One embodiment of the invention will now be described in conjunction with the accompanying drawings in which:

### BRIEF DESCRIPTION OF THE DRAWINGS

FIG. 1 is a perspective view of an agricultural tractor upon which the cab suspension system of the present invention is installed.

FIG. 2 is a schematic plan view of the tractor according to FIG. 1.

FIG. 3 is a schematic side elevational view of connection between the cab and the frame according to the illustrated embodiment of the present invention.

FIG. 4 is a sectional view along the line 4-4 of FIG. 3.

FIG. 5 is a schematic rear elevational view of the cab suspension system supported between the cab and the frame of the tractor.

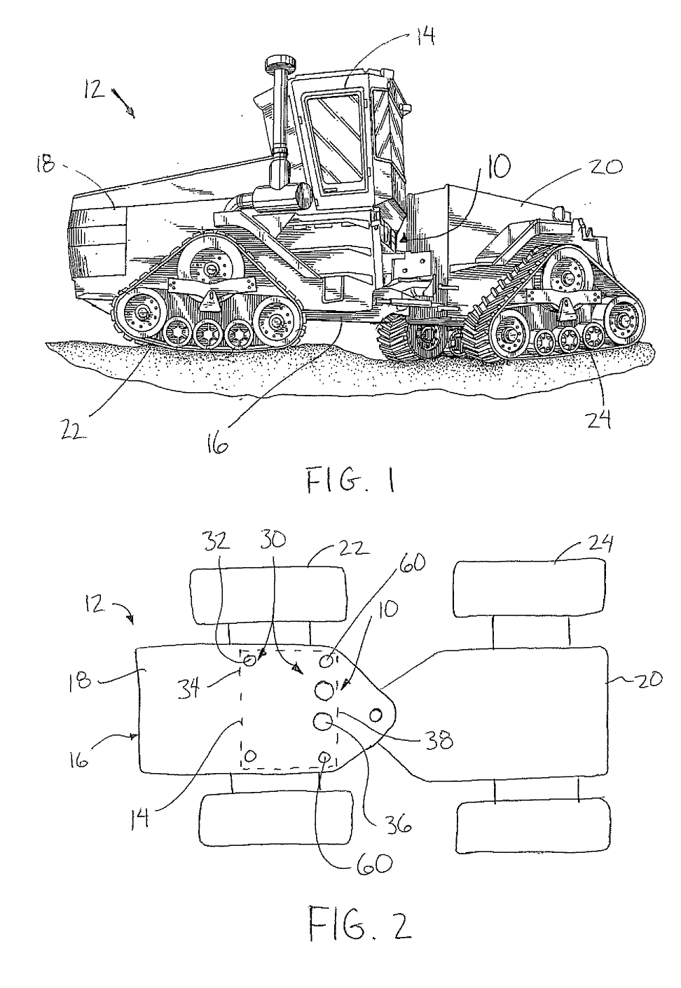

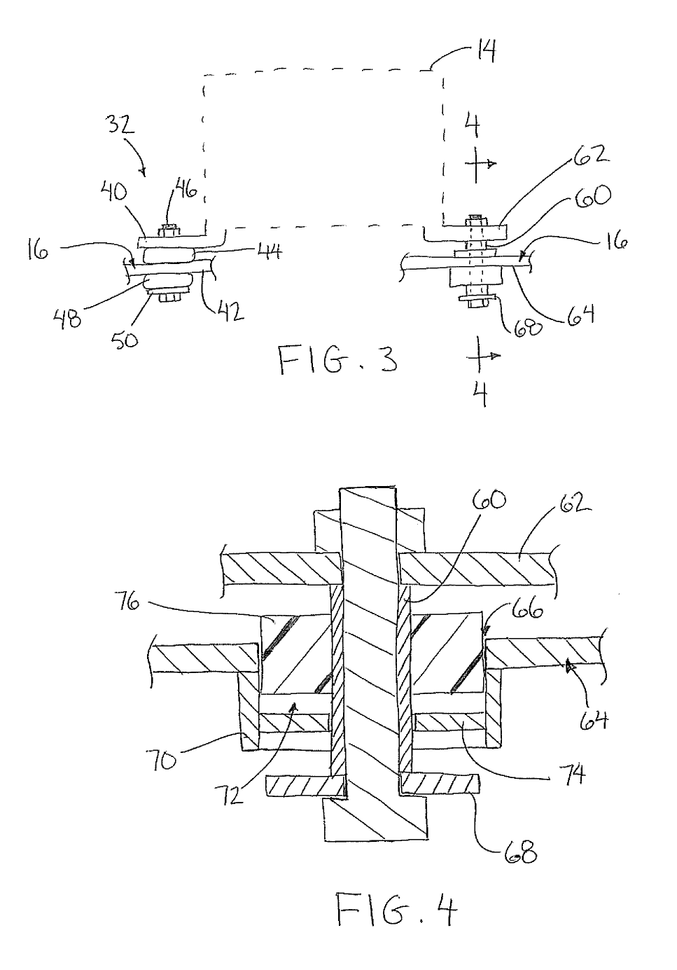

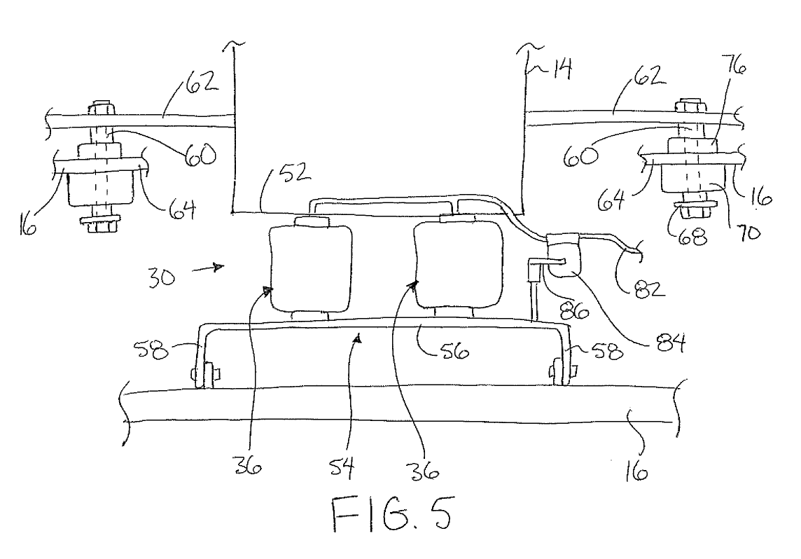

In the drawings like characters of reference indicate corresponding parts in the different figures.

### DETAILED DESCRIPTION

Referring to the accompanying figures there is illustrated a work vehicle cab suspension system generally indicated by reference numeral 10. The system 10 is particularly suited for use on a work vehicle, for example an agricultural tractor 12 of the type which requires the operator cab 14 to be secured to the frame 16 thereof such that the cab resists and is prevented from separation from the frame during a rollover of the vehicle.

The tractor 12 according to the illustrated embodiment comprises a Quadtrac model manufactured by Case IH, though the system 10 has advantages when used on other types of work vehicles supported either on pneumatic tires or tracks as made available by various manufacturers. In the illustrated embodiment, the tractor generally comprises a frame 16 including a front portion 18 and a rear portion 20 which are articulated relative to one another about a vertical axis for steering. The front portion 18 is supported on a pair of front tracks 22 while the rear portion is supported on a pair of rear tracks 24 such that the frame is supported for rolling movement across the ground on the tracks. The cab 14 is supported on the front frame portion 18 with the cab suspension system 10 being supported between the cab and the frame to isolate vibrations resulting from movement of the frame across the ground from being transmitted from the frame to the cab.

The system 10 comprises a plurality of suspension members 30 supported between the cab and the frame of the work vehicle at a plurality of locations spaced from one another both in the longitudinal working direction of the vehicle and in a lateral direction extending horizontally and perpendicularly to the longitudinal direction. More particularly the suspension members 30 comprise two front suspension members 32 supported at a front end 34 of the cab at laterally spaced apart positions on opposing sides of the cab. The suspension members also include two rear suspension members 36 which are supported at laterally spaced positions at the rear end 38 of the cab for supporting the rear end of the cab on the frame of the vehicle.

The two front suspension members 32 are mounted between an upper mount 40 forming a portion of the body of the cab and a lower mount 42 forming a portion of the vehicle frame. Both the upper and lower mounts 40 and 42 of each front suspension member comprise a generally horizontally oriented rigid plate having an aperture formed therein for alignment with the aperture of the other mount. A first resilient member 44 is mounted in compression between the upper mount and the lower mount. An aperture is formed in the first resilient member 44 for alignment with the apertures in the upper and lower mounts to receive a common threaded fastener 46 therethrough. The fastener 46 includes a head at one end and a nut threadably secured to the opposing end of the fastener to provide a clamping force to the upper and lower mounts therebetween.

A second resilient member 48 is mounted below the lower mount 42 and includes an aperture therein also for receiving the common fastener 46 therethrough. An end plate 50 with an aperture therein which receives the fastener 46 is mounted at one end of the second resilient member 48 opposite the lower mount 42 such that the second resilient member is clamped between the end plate 50 and the lower mount 42 by the head at one end of the fastener 46 being abutted against the end plate while the other end of the fastener abuts the upper mount 40 at the outer side thereof for compressing both first and second resilient members between opposing ends of the fastener.

The two rear suspension members 30 are also mounted between an upper mount 52 which forms part of the cab body and a lower mount 54 which forms a part of the vehicle frame. The upper mount 52 comprises a laterally extending member at the bottom rear of the cab so that the two rear suspension members 36 engage the upper mount 52 at spaced positions therealong. The lower mount 54 is formed by a frame extension member having a generally U-shaped configuration including a main portion 56 extending generally horizontally in a lateral direction directly below the upper mount to be parallel and spaced therebelow, and a pair of upright end portions 58 at opposing ends of the main portion 56 which extend downwardly for fixed mounting onto respective portions of the frame of the vehicle.

Each of the rear suspension members 36 comprises an air cushion having a resilient body containing a chamber of air under pressure therein which mounts under compression between the upper mount 52 of the body of the cab and the lower mount 54 of the frame of the vehicle. In this configuration, the front end of the operator cab is effectively hinged by the resilient members of the front suspension members under compression about a generally laterally extending axis at the front end of the cab while the rear end of the cab floats on the air cushions of the two rear suspension members 36.

To provide protection to adequately secure the cab to the vehicle frame in the event of a rollover of the vehicle, two rollover protection members 60 are additionally provided in association with the pair of rear suspension members 36 respectively. The two rollover protection members 60 are laterally spaced apart at opposing sides of the cab adjacent the rear end thereof so as to be spaced apart on opposing sides of the pair of rear suspension members 36 supported at evenly spaced positions between the two rollover protection members 60.

Each rollover protection member 60 is mounted between a respective upper mount 62 formed as a portion of the body of the cab which comprises a generally horizontal rigid plate, and a lower mount 64 which forms a fixed portion of the vehicle frame also in the form of a generally horizontal rigid plate. The rollover protection member 60 comprises a rigid metal, generally cylindrical rod member oriented in a generally vertical direction to define a generally linear sliding axis arranged such that the floating suspension movement between the rear end of the cab and the vehicle frame is restricted to a generally linear sliding movement in a vertical direction.

The rod forming the rollover protection member 60 is fixed at a top end to the upper mount 62 so as to depend downwardly from the upper mount to be slidably received within a respective aperture 66 formed in the respective lower mount 64. An end plate 68 is fixed to the lower end of the rollover protection member 60 which serves to secure the lower mount for sliding movement along the rollover protection member 60 for linear sliding movement along a longitudinal axis of the member 60 between the end plate 68 defining the lower limit of the sliding movement and the upper mount 62 defining the upper limit of the sliding movement.

The rollover protection member 60 comprises a tubular bushing or rod which receives a threaded fastener longitudinally therethrough. The fastener is a bolt has a head fixed at one end and a nut threadably secured to the other end. Apertures are provided in the upper mount and the end plate 60 which are suitably sized to receive the bolt therethrough but not be surrounding tubular bushing defining the rollover protection member 60 so that the member 60 is clamped between the upper mount and the end plate by the fastening of the fastener.

The lower mount of each rollover protection member 60 includes a cylindrical collar extension 70 in alignment with the aperture 66 in which the extension 70 extends downwardly from the plate forming the lower mount with the interior diameter of the collar and the aperture in the plate forming the lower mount being substantially identical and being much greater than the outer diameter of the tubular bushing forming the rollover protection member 60 received therethrough. Accordingly an annular gap 72 is defined between the outer diameter of the member 60 and the interior diameter of the aperture 66 formed in the lower mount plate and collar extension 70 extending downwardly therefrom.

An annular retainer ring 74 is mounted to span generally perpendicularly across the interior diameter of the collar extension 70 nearer to the bottom end thereof to substantially span the gap 72 between the rollover protection member and the interior surface of the collar extension member 70 which forms a generally annular housing through which the member 60 is received. A central aperture in the retainer ring 74 is close in diameter to the rollover protection member 60 for centering the member 60 within the annular housing defined by the collar extension 70 and the aperture 66 in the lower mount plate.

An annular cushion member 76 is supported directly above the retaining ring 74 within the collar extension 70 also to span the gap 72 between the interior diameter of the aperture 66 and the exterior diameter of the member 60. The annular cushion member 76 also has a height in an axial direction of linear sliding movement of the rollover protection member 60 which is greater than the actual distance of the collar extension 70 between the ring member 74 fixed therein and the plate defining the lower mount which locates the aperture 66 therein. Accordingly the annular cushion member 76 is arranged to be compressibly engaged under compression between the upper mount 62 and the annular retainer ring 74 of the lower mount before the upper and lower mounts contact one another for providing a cushioning effect in the axial direction.

The cushion is also snugly received within the gap 72 to provide some cushioning effect in a radial direction between the rollover protection member fixed to the upper mount and the surrounding inner surface of the cylindrical collar extension 70 of the lower mount. Compression of the annular cushion member 76 between the plate of the upper mount 62 and the ring 74 of the lower mount thus limits the further relative sliding movement between the cab and the vehicle frame in one direction while contact between the end plate at the bottom end of the member 60 and the annular retainer ring 74 defines a limit to the relative sliding movement between the vehicle frame and the cab in the opposing direction.

Air pressure in the air cushions of the rear suspension members is controlled so that the upper mount 62 of the cab floats above the lower mounts 64 of the vehicle frame at the desired height with the lower mount being positioned at a midpoint between the opposing limits of the relative linear sliding movement under normal conditions so that the cab is free to be deflected either upwardly or downwardly in relation to the vehicle frame while the weight of the cab at the rear end is maintained on the air cushions to minimize transfer of vibrations from the vehicle frame to the operator cab.

Air pressure in the air cushions is controlled by an adjustable control mechanism 80 on the vehicle frame which automatically adjusts the air pressure in the cushions to maintain the desired ride height of the cab relative to the vehicle frame regardless of the weight being supported in the cab. The mechanism receives air under pressure from a suitable supply 82 and operates a valve 84 for delivering an appropriate amount of the air under pressure from the supply 82 to the air cushions of the rear suspension members responsive to the ride height of the cab relative to the vehicle frame as determine by an adjustable lever 86.

Accordingly when the ride height of the cab is too low relative to the vehicle frame, the lever 86 is automatically deflected to operate the valve to supply greater air under pressure from the supply into the air cushions which thus increases the ride height. Once the desired ride height has been reached, the lever 86 is automatically deflected by the appropriate amount to discontinue further supply of air to the air cushion until further required. Similarly, the valve 84 can automatically vent the air pressure from the air cushion as required if the ride height of the cab is too great so as to be too near one of the opposing end limits of the relative linear sliding movement between the cab and the vehicle frame in the vertical direction of the rollover protection members 60.

The suspension system 10 of the present invention can be installed as a retrofit to existing work vehicles by replacing an existing pair of rear suspension members with the rollover protection members 60 and then adding a new pair of rear suspension members in the form of the air cushions as described above. When supported on a Quadtrac tractor available by Case IH, retrofitting may further involve mounting a frame extension member on the frame to which the new air cushion rear suspension members may be mounted.

In further embodiments, the suspension system of the present invention may be incorporated into new work vehicles at the time of manufacture wherever protection is required against rollovers by providing rollover protection members 60 which are arranged to resist separation of the cab from the frame during a rollover of the vehicle. In this instance all of the benefits of the safety of the rollover protection member 60 of the present inventions can be realised while at the same time realising the benefits of an air cushion suspension system which is unaffected by the additional safety precautions of incorporating rollover protection members 60 into the vehicle. The suspension system 10 of the present invention is particularly suited for the IHC STX Quad Tractor. This tractor has four tracks instead of rubber tires which create extreme amounts of vibration that are transmitted into the cab resulting in operator discontent, noise and excessive cab vibration related rattles, failures, etc.

The system 10 solves the problem of enhancing the comfort of the machines operation while maintaining the roll over protection (R.O.P.) and at the same time maintaining the smooth active action of an air ride system. This challenge was met by the design of the rear cab mounts redesigned to a large 1.75 inch exterior diameter×4.75 inch long bushings moving inside a rubber cushion secured to the existing cab mounts by a 1 inch×7 inch grade 8 bolt, giving the cab the ability to move 1.5 to 2 inches both up and down. The enlarged diameter of the bushing relative to the bolt increases the shear strength of the bolt alone. This floating also isolates the cab from direct frame contact thereby reducing the noise and vibration transmitted into the operator's station.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A cab suspension system for a work vehicle comprising a frame supported for rolling movement along the ground and an operator cab arranged to be supported on the frame and for supporting an operator of the work vehicle therein, the system comprising:
a plurality of suspension members arranged for supporting the cab on the frame;
at least one of the suspension members comprising an air cushion member arranged to be supported between the cab and the frame of the work vehicle; and
at least one rollover protection member arranged to resist separation of the cab from the frame during a rollover of the work vehicle;
said at least one rollover protection member being arranged to couple the cab and the frame for sliding movement relative to one another.

2. The system according to claim 1 wherein the rollover protection member is arranged to support the cab for sliding movement relative to the frame in a substantially vertical direction between an upper limit and a lower limit, and wherein said air cushion member is arranged to support the cab on the frame spaced between the upper limit and the lower limit of said at least one rollover protection member.

3. The system according to claim 1 wherein said at least one suspension member comprising the air cushion member and said at least one rollover protection member being arranged to be supported together at one end of the cab opposite other ones of the suspension members arranged to be supported at the other end of the cab.

4. The system according to claim 3 wherein said at least one rollover protection member is arranged to be supported at a rear end of the cab and said other ones of the suspension members are arranged to be supported at a front end of the cab.

5. The system according to claim 1 wherein said at least one rollover protection member comprises two rollover protection members laterally spaced apart from one another and wherein said at least one of the suspension members comprising the air cushion is located between the two rollover protection members.

6. The system according to claim 1 wherein said at least one rollover protection member comprises a rigid rod member, a first mount arranged to fix the rigid rod member to one of the cab and the frame and a second mount arranged to be fixed to the other one of the cab and the frame, the second mount being arranged to be supported for sliding movement along the rigid rod member.

7. The system according to claim 6 wherein there is provided an annular housing supported on the second mount and arranged to receive the rod member therethrough such that an annular gap is defined between the annular housing and the rod member, and wherein there is provided an annular cushion member of resilient material arranged to span the annular gap.

8. The system according to claim 7 wherein there is provided a retainer member fixed adjacent one end of the annular housing opposite the first mount, the annular cushion member being arranged to be compressed between the retainer member and the first mount.

9. The system according to claim 6 wherein there is provided an end plate fixed to one end of the rod member opposite the first mount, the second mount being slidable along the rod member between the first mount and the end plate.

10. The system according to claim 9 wherein the rod member is generally tubular and wherein there is provided a fastener extending through the rod member and through co-operating apertures in the first mount and in the end plate respectively, the tubular rod member being arranged to be clamped between the end plate and the first mount by the fastener extending therethrough.

11. The system according to claim 6 wherein the first mount comprises an upper mount arranged to be supported on the cab and the second mount comprises a lower mount arranged to be supported on the frame.

12. The system according to claim 1 wherein said at least one rollover protection member is arranged to be mounted in place of a manufacturer installed suspension member mounted under compression between the cab and the frame.

13. The system according to claim 1 in combination with an agricultural tractor.

14. A tractor comprising:
a frame supported for rolling movement along the ground;
an operator cab arranged to be supported on the frame and arranged for supporting an operator of the work vehicle therein;
a plurality of suspension members arranged for supporting the cab on the frame;
at least one of the suspension members comprising an air cushion member arranged to be supported between the cab and the frame of the tractor; and
at least one rollover protection member arranged to resist separation of the cab from the frame at said at least one air cushion member during a rollover of the tractor;
said at least one rollover protection member being arranged to couple the cab and the frame for sliding movement relative to one another.

15. The system according to claim 14 wherein the rollover protection member supports the cab for sliding movement relative to the frame in a substantially vertical direction between an upper limit and a lower limit, and wherein said air cushion member supports the cab on the frame spaced between the upper limit and the lower limit of said at least one rollover protection member.

16. The system according to claim 14 wherein said at least one suspension member comprising the air cushion member and said at least one rollover protection member are supported together at one end of the cab opposite other ones of the suspension members which are supported at the other end of the cab.

17. The system according to claim 14 wherein said at least one rollover protection member comprises a rigid rod member, a first mount fixing the rigid rod member to one of the cab and the frame and a second mount fixed to the other one of the cab and the frame, the second mount being supported for sliding movement along the rigid rod member.

18. The system according to claim 17 wherein there is provided an annular housing supported on the second mount and receiving the rod member therethrough such that an annular gap is defined between the annular housing and the rod member, and wherein there is provided an annular cushion member of resilient material spanning the annular gap.

19. The system according to claim 17 wherein there is provided an end plate fixed to one end of the rod member opposite the first mount, the second mount being slidable along the rod member between the first mount and the end plate.

20. The system according to claim 19 wherein the rod member is generally tubular and wherein there is provided a fastener extending through the rod member and through co-operating apertures in the first mount and in the end plate respectively, the tubular rod member being clamped between the end plate and the first mount by the fastener extending therethrough.
